(19) United States
(12) Patent Application Publication
(10) Pub. No.: US 2012/0097468 A1
(43) Pub. Date: Apr. 26, 2012

(54) CONSTRUCTION MACHINE

(75) Inventors: Kazuyuki TAKEDA, Hiroshima-shi (JP); Satoshi Kurushima, Hiroshima-shi (JP); Daiki Nakabayashi, Hiroshima-shi (JP)

(73) Assignee: KOBELCO CONSTRUCTION MACHINERY CO., LTD., Hiroshima-shi (JP)

(21) Appl. No.: 13/270,458

(22) Filed: Oct. 11, 2011

(30) Foreign Application Priority Data
Oct. 20, 2010 (JP) 2010-235770

(51) Int. Cl. F16L 3/10; F16L 3/22; E02F 9/08

(52) U.S. Cl. 180/311; 248/74.1

(57) ABSTRACT

A construction machine is provided with a clamp receiver 30 with a projecting attachment pin 42, and a clamp body 31 attached onto the clamp receiver 30. The clamp body 31 includes a pair of clamping members 32, 33 which sandwich a hose 17 from both sides of the hose 17 in the diameter direction thereof, and a coupling mechanism which is operable to couple the clamping members 32, 33 to each other in a state that the hose 17 is sandwiched between the clamping members 32 and 33. Each of the clamping members 32, 33 is formed with a clamping member pin hole 40 for passing the attachment pin 42 therethrough. The clamp body 31 is thereby attached onto the clamp receiver 30 in a state that the clamp body 31 is movable in the length direction of the attachment pin 42.

### BACKGROUND OF THE INVENTION

1. Field of the Invention

The present invention relates to a pipe clamp for holding a pipe such as a delivery hose for connecting between a hydraulic pump and a control valve onto a frame of a construction machine such as a hydraulic shovel.

2. Description of the Background Art

Conventionally, as disclosed in e.g. Japanese Unexamined Patent Publication No. 2001-317081 (hereinafter, called as patent literature 1), there is known a clamp for holding a hydraulic pipe for connecting between a hydraulic pump and a control valve onto a frame of a hydraulic shovel. Hereinafter, an arrangement is described on the basis of a reference example, in which a hydraulic shovel is incorporated with the clamp disclosed in patent literature 1, referring to FIGS. 7 through 9.

The hydraulic shovel shown in FIG. 7 is provided with a crawler-type lower propelling body 1, an upper slewing body 2 loaded on the lower propelling body 1 slewably about an axis perpendicular to the ground, and a working attachment 6 attached to rise and fall with respect to the upper slewing body 2. The working attachment 6 is provided with a boom 3, an arm 4, and a bucket 5.

As shown in FIG. 7 and FIG. 8, the upper slewing body 2 is provided with an upper frame 7 as a base portion on which the working attachment 6 is attached, a cabin 8 loaded on the upper frame 7, a guard member 9 such as a guard panel, an engine 14, a hydraulic pump 15, a control valve 16, a plurality of delivery hoses (hereinafter, simply called as hoses) 17, and a pipe clamp 19.

In the specification, front and rear directions (or a longitudinal direction) and left and right directions (or a lateral direction) are defined based on the premise that the cabin 8 is loaded on a front-left part of the hydraulic shovel.

The cabin 8 is loaded on the upper frame 7 at a front part of the upper frame 7. On the other hand, the guard member 9 is disposed at a rear part of the upper frame 7 to form an engine room 10.

The upper frame 7 is provided with left and right vertical plates 11, 12 extending longitudinally substantially over the entire length of the upper frame 7 in front and rear directions, and a partition plate 13 extending laterally in left and right directions orthogonal to the vertical plates 11, 12 at a longitudinally intermediate portion of the upper frame 7.

The space above the upper frame 7 is divided into a front section S1 and a rear section S2 by the partition plate 13. The engine room 10 is formed in the rear section S2.

The engine 14 is disposed in the rear section S2 (namely in the engine room 10), with the length direction thereof being aligned with the left and right directions of the hydraulic shovel. Normally, the hydraulic pump 15 to be driven by the engine 14 is disposed on one of left and right sides of the engine 14 (normally, on the left side as shown in FIG. 8, hereinafter, description is made based on this example).

On the other hand, the cabin 8 is loaded on the left side of the front section 51, and the control valve 16 is disposed on the right side of the front section S1. The hoses 17 are adapted to connect between the hydraulic pump 15 and the control valve 16.

Many other devices are disposed in the front the section S1 and the rear section S2. However, since these devices are not relevant to the invention, illustration thereof is omitted.

The hoses 17 are connected between the hydraulic pump 15 and the control valve 16 through a cutaway 18 (see FIG. 9) formed in the partition plate 13. Intermediate portions of the hoses 17 are held by a pipe clamp 19. Specifically, the pipe clamp 19 is disposed on the front surface side of the partition plate 13, while facing the cutaway 18.

The pipe clamp 19 includes a clamp receiver 20 constituted of a metal plate bulging from the partition plate 13 in a shelf-like configuration, as shown in FIG. 9, a pair of upper and lower rubber clamping members 21, 22 placed one over the other onto the clamp receiver 20, a clamp presser 23 constituted of a metal plate and placed on the top surface of the upper clamping member 21, and a plurality of tubular spacers 24 passing through the clamping members 21, 22.

Inserting a fastening bolt 25 through each of the spacers 24, and engaging a nut 26 with each of the fastening bolts 25 in a state that the respective hoses 17 are sandwiched between the clamping members 21, 22 allows the respective hoses 17 to be held by the pipe clamp 19. Specifically, the four members i.e. the clamp receiver 20, the clamping members 21, 22, and the clamp presser 23 are integrally united to each other in a state that the respective hoses 17 are sandwiched, whereby the respective hoses 17 are fixed onto the partition plate 13 (namely, onto the upper frame 7).

In FIG. 9, the reference sign 27 denotes a lower washer which is interposed between a head portion of each of the fastening bolts 25 and the clamp receiver 20, the reference sign 28 denotes an upper washer which is interposed between each of the nuts 26 and the clamp presser 23, and the reference sign 29 denotes a floor plate.

In the pipe clamp 19 shown in FIG. 8 and FIG. 9, as described above, the four members i.e. the clamp receiver 20, the clamping members 21, 22, and the clamp presser 23 are integrally united to each other, and the four members and the hoses 17 are fixed in all directions as one unit.

In the above arrangement, vibrations by hydraulic pulsation within the hoses 17 are directly transmitted to the upper frame 7 via the four members. As a result, particularly, noises in the cabin 8 may be intolerably large.

### SUMMARY OF THE INVENTION

An object of the invention is to provide a construction machine that enables to suppress transmission of vibrations of a pipe to a frame.

An aspect of the invention is directed to a construction machine including a frame, with an attachment pin projecting therefrom; and a clamp body attached to the frame. The clamp body includes a pair of clamping members which sandwich a pipe from both sides of the pipe in a diameter direction thereof; and a coupling mechanism which is operable to couple the pair of clamping members to each other in a state that the pipe is sandwiched between the pair of clamping members. Each of the pair of clamping members is formed with a clamping member pin hole for passing the attachment pin therethrough, and the attachment pin passes through both of the pair of clamping members via the clamping member pin holes, whereby the clamp body is attached onto the frame in a state that the clamp body is movable in a length direction of the attachment pin.

According to the invention, it is possible to suppress transmission of vibrations of the pipe to the frame.

These and other objects, features and advantages of the present invention will become more apparent upon reading the following detailed description along with the accompanying drawings.

### BRIEF DESCRIPTION OF THE DRAWINGS

FIG. 1 is an exploded perspective view enlargedly showing a part of a construction machine embodying the invention.

FIG. 2 is a perspective view showing an assembled state of a clamp body shown in FIG. 1.

FIG. 3 is a perspective view of the clamp body and a clamp receiver shown in FIG. 2, when viewed from below.

FIG. 4 is a cross-sectional view showing a state before the clamp body is attached to the clamp receiver.

FIG. 5 is a cross-sectional view showing a state that the clamp body is attached to the clamp receiver.

FIG. 6 is an enlarged sectional view taken along the line VI-VI in FIG. 5.

FIG. 7 is a schematic side view of an example of a hydraulic shovel to which the invention is applied.

FIG. 8 is a schematic plan view of an upper frame of the hydraulic shovel shown in FIG. 7.

FIG. 9 is an enlarged sectional view taken along the line IX-IX in FIG. 8.

### DESCRIPTION OF THE PREFERRED EMBODIMENTS

In the following, an embodiment of the invention is described referring to the drawings. The following embodiment is merely an example embodying the invention, and does not limit the technical scope of the invention.

Referring to FIG. 7, a hydraulic shovel as an example of a construction machine embodying the invention is provided with a crawler-type lower propelling body 1, an upper slewing body 2 loaded on the lower propelling body 1 slewably about an axis perpendicular to the ground, and a working attachment 6 attached to rise and fall with respect to the upper slewing body 2. The working attachment 6 is provided with a boom 3, an arm 4, and a bucket 5.

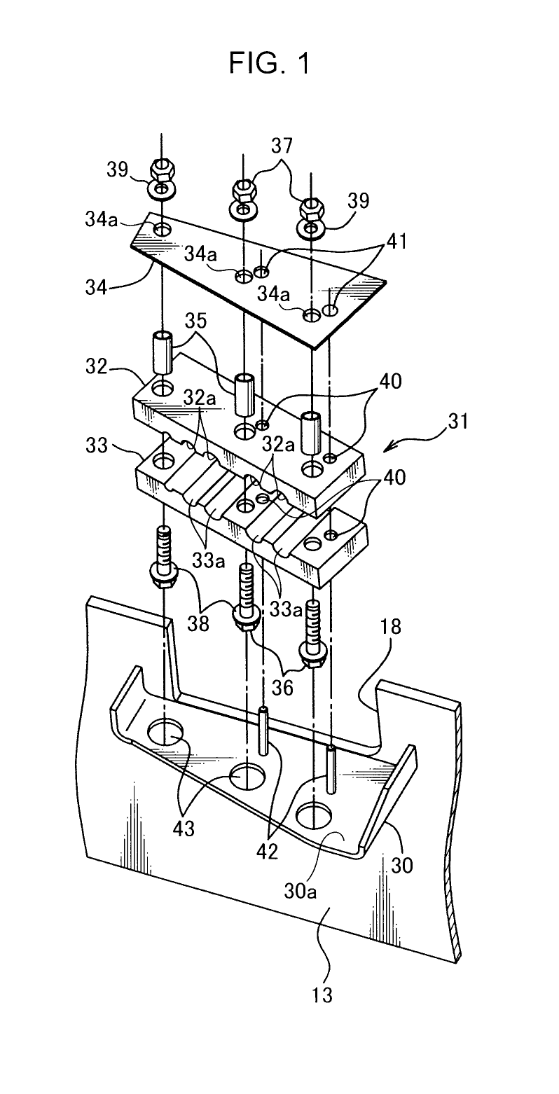

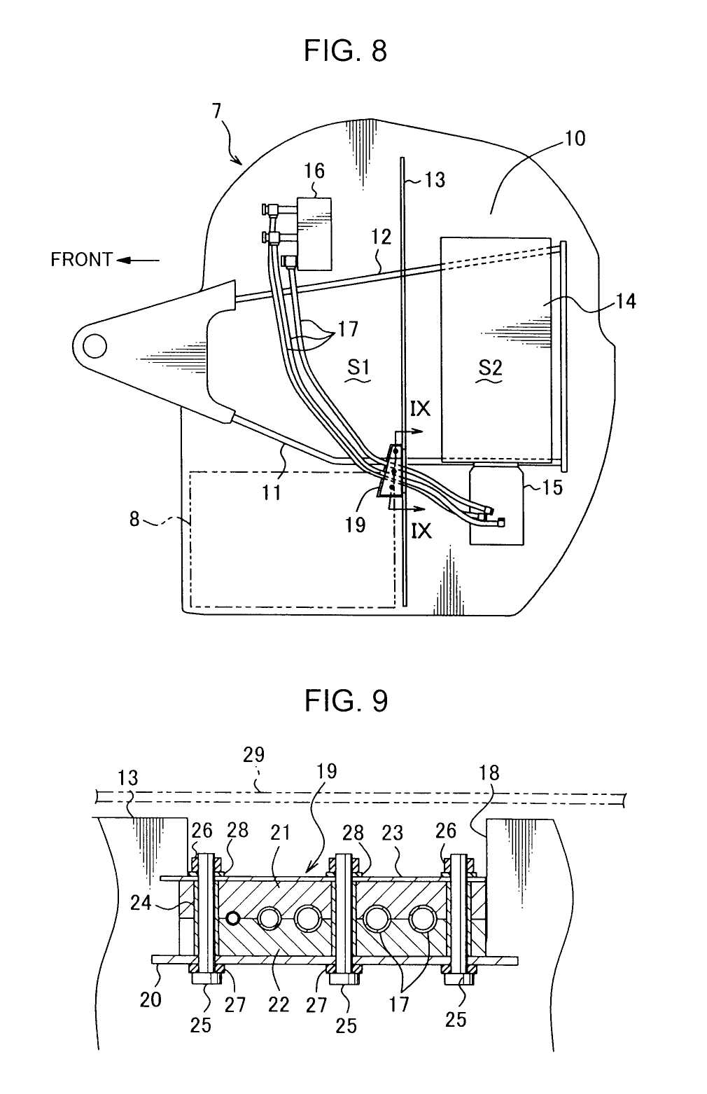

As shown in FIG. 7 and FIG. 8, the upper slewing body 2 is provided with an upper frame 7 as a base portion on which the working attachment 6 is attached, a cabin 8 loaded on the upper frame 7, a guard member 9 such as a guard panel, an engine 14, a hydraulic pump 15, a control valve 16, a plurality of delivery hoses (hereinafter, simply called as hoses) 17, a floor plate 29 (see FIG. 5), and a clamp body 31 (see FIG. 1).

The upper frame 7 is a metal member, and is provided with left and right vertical plates 11, 12 extending longitudinally substantially over the entire length of the upper frame 7 in front and back directions, and a partition plate 13 extending laterally in left and right directions orthogonal to the vertical plates 11, 12 at a longitudinally intermediate portion of the upper frame 7.

The space above the upper frame 7 is divided into a front section S1 and a rear section S2 by the partition plate 13. An engine room 10 is formed in the rear section S2.

The engine 14 is disposed in the rear section S2 (namely in the engine room 10), with the length direction thereof being aligned with the lateral direction (left and right directions) of the hydraulic shovel. Normally, the hydraulic pump 15 to be driven by the engine 14 is disposed on one of left and right sides of the engine 14 (normally, on the left side as shown in FIG. 8, hereinafter, description is made based on this example).

On the other hand, the cabin 8 is loaded on the left side of the front section S1, and the control valve 16 is disposed on the right side of the front section 51. The hoses 17 are adapted to connect between the hydraulic pump 15 and the control valve 16.

The hoses 17 are connected between the hydraulic pump 15 and the control valve 16 through a cutaway 18 (see FIG. 1) formed in the partition plate 13. Intermediate portions of the hoses 17 are held by the clamp body 31 to be described later.

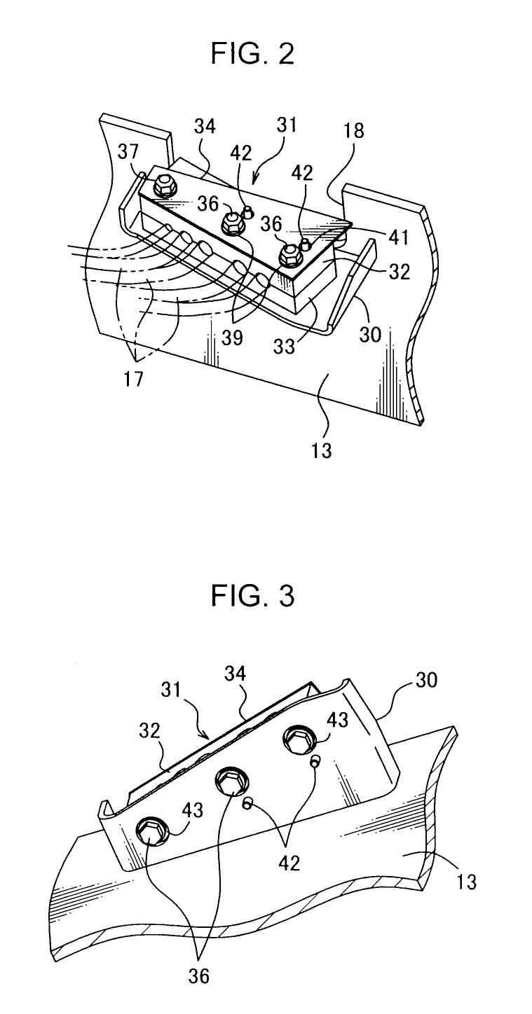

As shown in FIGS. 1 through 6, the hydraulic shovel in the embodiment is provided with a metal clamp receiver 30 (a part of the upper frame 7) which bulges forwardly from a front surface of the partition plate 13, and with the clamp body 31 which is supported on the clamp receiver 30.

The clamp receiver 30 is a metal plate with left and right ends thereof being bent upwardly. Further, the clamp receiver 30 has a placement surface 30a which is formed between the left and right bent portions, and which is adapted to place the clamp body 31 thereon. The placement surface 30a is a surface orthogonal to a slewing axis about which the upper slewing body 2 is slewed. Further, the clamp receiver 30 has two attachment pins 42, 42 projecting upwardly from the placement surface 30a. These attachment pins 42 are insertable into the clamp body 31 so that the clamp body 31 to be described later is attached onto the clamp receiver 30 in a state that the clamp body 31 is vertically movable.

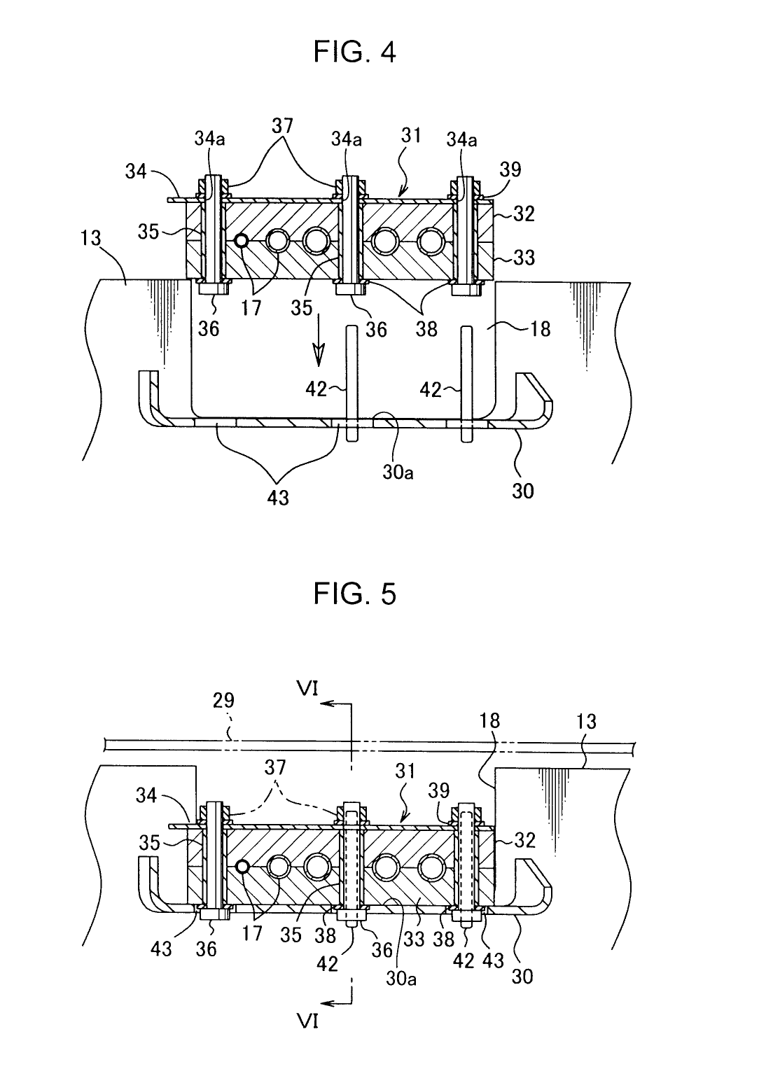

The method for fixing the attachment pin 42 onto the clamp receiver 30 is not specifically limited. Specifically, as shown in FIG. 4, a lower end of the attachment pin 42 may be fixedly attached to the clamp receiver 30 by e.g. welding in a state that the attachment pin 42 passes through the clamp receiver 30. Further alternatively, a lower end of the attachment pin 42 may be fixedly attached to the placement surface 30a of the clamp receive 30.

The clamp body 31 is formed on the front surface side of the partition plate 13, while facing the cutaway 18. Specifically, the clamp body 31 is disposed horizontally in a state that the clamp body 31 is placed on the placement surface 30a of the clamp receiver 30.

Further, the clamp body 31 holds intermediate portions of the respective hoses 17. Specifically, the clamp body 31 is provided with a pair of upper and lower clamping members 32, 33 for fixing the respective hoses 17 while holding the respective hoses 17 from both sides thereof in the diameter direction thereof, and a coupling mechanism for coupling the clamping members 32 and 33 to each other in a state that the respective hoses 17 are sandwiched therebetween.

The clamping members 32, 33 are made of an elastic material such as rubber. Further, each of the clamping members 32, 33 is formed with two clamping member pin holes 40 for passing the corresponding attachment pins 42 therethrough. The clamping member pin holes 40 are respectively formed in a transversely center portion (a center portion in left and right directions) and in a left portion of each of the clamping members 32, 33 at positions corresponding to the attachment pins 42. The clamping member pin holes 40 in the clamping member 32, and the clamping member pin holes 40 in the clamping member 33 are formed at such a position that the clamping member pin holes 40 in the clamping member 32, and the clamping member pin holes 40 in the clamping member 33 align with each other in a state that the clamping members 32, 33 are placed one over the other. Further, recess grooves 32a, 33a for receiving the hoses 17 are respectively formed in the clamping members 32, 33 at positions opposite to each other in a state that the clamping member pin holes 40 in the clamping member 32, and the clamping member pin holes 40 in the clamping member 33 align each other. The recess grooves 32a, 33a each has an inner lateral surface which is configured to firmly contact with an outer lateral surface of the corresponding hose 17.

The coupling mechanism is provided with a metal clamp presser 34 which is placed over the top surface of the upper clamping member 32, a plurality of tubular metal spacers 35 which pass through both of the clamping members 32 and 33, fastening bolts 36 which pass through the corresponding metal spacers 35 from below, nuts 37 which are screwed into upper ends of the corresponding fastening bolts 36, metal washers 38 which are disposed between heads of the corresponding fastening bolts 36 and the lower clamping member 33, and metal washers 39 which are disposed between the corresponding nuts 37 and the clamp presser 34.

The clamp presser 34 is a metal plate for holding the clamping members 32, 33. Specifically, the clamp presser 34 is formed with three insertion holes 34a for passing lead ends (screw portions) of the fastening bolts 36 therethrough, and each of which has a size incapable of passing the metal spacer 35. Further, the clamp presser 34 is formed with two clamp presser pin holes 41 at positions corresponding to the clamping member pin holes 40 formed in the clamping members 32, 33.

The metal spacer 35 is adapted to keep the thickness of the pair of clamping members 32, 33 to a predetermined size or more against a fastening force by the fastening bolt 36 and the nut 37. Specifically, the metal spacer 35 keeps the thickness of the pair of clamping members 32, 33 by restricting the washers 38, 39 from coming close to each other at both ends thereof.

The fastening bolt 36 and the nut 37 press the pair of clamping members 32, 33 toward the clamp presser 34. Specifically, the pair of clamping members 32, 33 are held between the washers 38, 39 by engagement of the lead ends of the fastening bolts 36 with the nuts 37. Thus, the three members i.e. the pair of clamping members 32, 33 and the clamp presser 34 are integrally united to each other.

In this embodiment, the diameter of the clamping member pin hole 40 is set larger than the diameter of the attachment pin 42, and is set smaller than the diameter of the clamp presser pin hole 41.

Specifically, the following relationship is established:

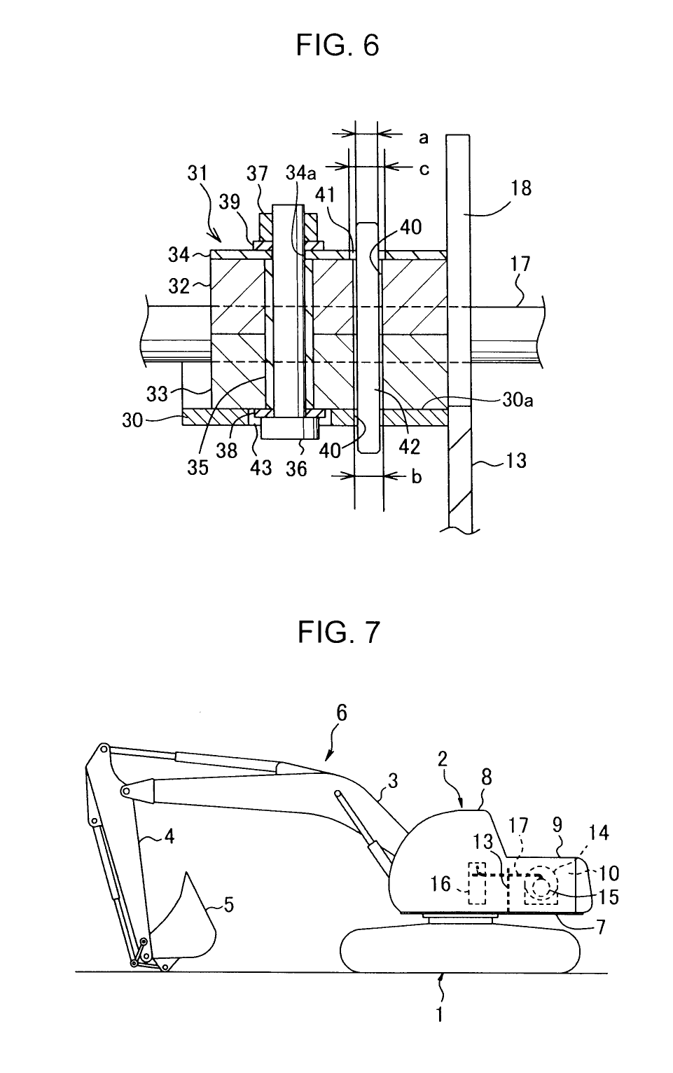

a≦b≦c

where a is the diameter of the attachment pin 42, b is the diameter of the clamping member pin hole 40 of the clamping members 32, 33, and c is the diameter of the clamp presser pin hole 41 of the clamp presser 34 (see FIG. 6).

In other words, the clamping member pin hole 40 and the clamp presser pin hole 41 are formed into a clearance hole having a larger diameter than the diameter of the attachment pin 42, and the clamp presser pin hole 41 is formed into a hole having a larger diameter than the diameter of the clamping member pin hole 40.

As shown in FIG. 1 and FIG. 5, the clamp receiver 30 in this embodiment is formed with three relief holes 43 in a region between the left and right bent portions of the clamp receiver 30. The three relief holes 43 vertically pass through the clamp receiver 30. These relief holes 43 are adapted to avoid contact between the heads of the fastening bolts 36 and the washers 38, and the clamp receiver 30. Specifically, each of the relief holes 43 is formed in the clamp receiver 30 at a position corresponding to the corresponding fastening bolt 36. Further, each of the relief holes 43 has a larger diameter than the diameter of the head of the fastening bolt 36 and the diameter of the lower washer 38 to avoid contact between the clamp receiver 30, and the head of the fastening bolt 36 and the washer 38.

The clamp body 31 is attached onto the clamp receiver 30 as follows. Firstly, as shown in FIG. 4, the respective hoses 17 are sandwiched between the clamping members 32 and 33, and the clamp presser 34 is placed on the clamping members 32, 33. In this state, the three members i.e. the clamping members 32, 33 and the clamp presser 34 are fastened to each other by the fastening bolts 36 and the nuts 37. The clamp body 31 is assembled in this way.

Next, as shown in FIGS. 5, 6, the clamp body 31 is placed on the placement surface 30a of the clamp receiver 30 while allowing the attachment pins 42, 42 to pass through the clamping member pin holes 40 and through the clamp presser pin holes 41.

With the above operation, the clamp body 31 is attached onto the clamp receiver 30 in a state that the clamp body 31 is vertically movable in the length direction (up and down directions) of the attachment pins 42, 42.

As described above, in this embodiment, inserting the attachment pins 42 in the clamping member pin holes 40 enables to attach the clamp body 31 onto the clamp receiver 30 in a state that the clamp body 31 is movable in the length direction of the attachment pin 42. In other words, the clamp body 31 is attached onto the upper frame 7 in a state that vibrations from the clamp receiver 30 are cut off, unlike the clamp arrangement shown in FIG. 9, in which the clamp body and the frame are fixed in all directions as one unit. In this embodiment, it is possible to suppress transmission of vibrations by hydraulic pulsation of the hoses 17 to the upper frame 7.

The embodiment is particularly advantageous in reducing noises in a cabin resulting from vibrations, and in improving operability and comfort in working in a construction machine constructed such that the cabin 8 is loaded on the upper frame 7 like a hydraulic shovel.

Further, the clamp body 31 is securely held onto the clamp receiver 30 by insertion of the attachment pins 42 through the clamping member pin holes 40 and through the clamp receiver pin holes 41. With the above arrangement, the clamp body 31 can sufficiently function as means for holding the respective hoses 17 at a predetermined position.

In this embodiment, the clamping members 32, 33 are made of an elastic material; and the clamp body 31 is provided with the fastening bolts 36 and the nuts 37 for pressing the clamping members 32, 33 toward the clamp presser 34, and with the metal spacers 35 for keeping the thickness of the clamping members 32, 33. With this arrangement, vibrations of the hoses 17 can be absorbed by elastic deformation of the clamping members 32, 33, and the vibration absorbing function can be effectively secured by suppressing excessive pressing of the clamping members 32, 33 by the metal spacers 35.

In this embodiment, the clamp body 31 is placed on the placement surface 30a in such a manner that the clamp presser 34 faces upward, and the contact between the heads of the fastening bolts 36 and the washers 38, and the clamp receiver 30 is avoided by the formation of the relief holes 43. With this arrangement, the contact between the members made of a metal (i.e. the clamp receiver 30, the clamp presser 34, the fastening bolts 36, and the nuts 37) is avoided to thereby effectively suppress transmission of vibrations via these metal members.

In this embodiment, each of the relief holes 43 has such a size as to avoid the contact between the washer 38 and the clamp receiver 30. With this arrangement, the contact between the washers 38 and the clamp receiver 30 is avoided, while suppressing rotation of the clamping members 32, 33 together with the fastening bolts 36 and the nuts 37, whereby transmission of vibrations from the hoses 17 to the upper frame 7 can be suppressed.

In this embodiment, the diameter “b” of the clamping member pin hole 40 is set larger than the diameter “a” of the attachment pin 42 and is set smaller than the diameter “c” of the clamp presser pin hole 41. With this arrangement, the attachment pins 42 are contacted with the pair of clamping members 32, 33 before the attachment pins 42 is contacted with the clamp presser 34 when the clamp body 31 is vibrated, whereby the contact between the attachment pins 42 and the clamp presser 34, both of which are made of a metal, can be avoided. This enables to effectively suppress transmission of vibrations from the hoses 17 to the upper frame 7.

Further, the contact between the heads of the fastening bolts 36 and the washers 38, and the clamp receiver 30 is avoided by the formation of the relief holes 43 as described above. Thus, it is possible to prevent transmission of vibrations resulting from the contact between the heads of the fastening bolt 36 and the washers 38, and the clamp receiver 30. This enables to enhance the vibration transmission suppressing effect.

In the case where the clamp body 31 is disposed beneath the cabin 8, as shown in FIG. 5, the floor plate 29 is disposed above the clamp body 31. With this arrangement, the existence of the floor plate 29 prevents disengagement of the clamp body 31 from the attachment pins 42. Thus, the above arrangement enables to keep the inserted state of the attachment pins 42 in the clamp body 31, even if the clamp body 31 is vertically vibrated by hydraulic pulsation of the hoses 17.

<Modifications>

(1) In the embodiment, the clamping members 32, 33 are made of an elastic material. Alternatively, the clamping members 32, 33 may be made of a metal.

In the above modification, there is no likelihood that fastening deficiency of the fastening bolts 36 may occur by elastic deformation of the clamping members 32, 33. Accordingly, the metal spacers 35 are not essentially required. Further, the clamp presser 34 is also not essentially required, and may be provided as necessary.

As compared with the embodiment, in the modification, since the clamping members 32, 33 are metal-contacted with the attachment pins 42, the amount of vibrations transmitted may be increased. However, since the clamp body 31 is attached to be movable in the length direction of the attachment pin 42, it is possible to reduce the amount of vibrations transmitted, as compared with the art, in which the clamping members and the clamp receiver are completely integrally united.

(2) In the embodiment, the fastening bolts 36 are inserted through the clamping member pin holes 40 and through the clamp presser pin holes 41 from below with a play. Alternatively, the fastening bolts 36 may be inserted through the clamp presser pin holes 41 and through the clamping member pin holes 40 from above with a play. In other words, the nuts 37 and the washers 39 may be disposed beneath the lower clamping member 33.

In the above modification, the diameter of each of the relief holes 43 is set to such a size as to avoid the contact between the nut 37 and the washer 39, and the clamp receiver 30.

(3) In the embodiment, the partition plate 13 bulges from the clamp receiver 30, and the clamp body 31 is horizontally disposed onto the clamp receiver 30. The invention is not limited to the above. Specifically, the above arrangement may be applied to a case where the clamp body 31 is directly disposed on the upper frame 7.

Further, in the embodiment, the clamp body 31 is attached in such a manner that the clamping members 32, 33 are vertically disposed one above the other. Alternatively, the clamp body 31 may be attached in such a manner that the clamping members 32, 33 are disposed side by side.

In the above modification, the arrangement substantially the same as in the embodiment may be applied. It is, however, desirable to provide a stopper for preventing horizontal disengagement of the clamp body 31 from the attachment pins 42, at the lead end side of the attachment pins 42.

The foregoing embodiment and modifications mainly include the invention having the following features.

An aspect of the invention is directed to a construction machine including a frame, with an attachment pin projecting therefrom; and a clamp body attached to the frame. The clamp body includes a pair of clamping members which sandwich a pipe from both sides of the pipe in a diameter direction thereof; and a coupling mechanism which is operable to couple the pair of clamping members to each other in a state that the pipe is sandwiched between the pair of clamping members. Each of the pair of clamping members is formed with a clamping member pin hole for passing the attachment pin therethrough, and the attachment pin passes through both of the pair of clamping members via the clamping member pin holes, whereby the clamp body is attached onto the frame in a state that the clamp body is movable in a length direction of the attachment pin.

According to the above arrangement of the invention, it is possible to attach the clamp body onto the frame in a state that the clamp body is movable in the length direction of the attachment pin by passing the attachment pin through the clamping member pin holes. In other words, it is possible to attach the clamp body onto the frame in a state that vibrations from the frame are cut off, unlike the conventional clamp arrangement in which the clamp body and the frame are fixed in all directions as one unit. Therefore, according to the above arrangement of the invention, it is possible to suppress transmission of vibrations by hydraulic pulsation of a pipe to a frame.

Thus, the above arrangement is particularly advantageous in reducing noises in a cabin, and in improving operability and comfort in working in a construction machine constructed such that a cabin is loaded on an upper frame like a hydraulic shovel.

In the construction machine, preferably, the pair of clamping members may be made of an elastic material, the coupling mechanism may include a metal clamp presser which is placed on one of the pair of clamping members, with the one of the pair of clamping members being interposed between the clamp presser and the other of the pair of clamping members, a pressing mechanism which presses the other of the pair of clamping members toward the clamp presser, and a spacer which keeps a thickness of the pair of clamping members to a predetermined size or more against a pressing force by the pressing mechanism, and the clamp presser may be formed with a clamp presser pin hole for passing the attachment pin therethrough, at a position corresponding to the clamping member pin hole.

In the above arrangement, the pair of clamping members are made of an elastic material, and the coupling mechanism includes the pressing mechanism which presses the pair of clamping members toward the clamp presser, and the spacer which keeps the thickness of the pair of clamping members against a pressing force by the pressing mechanism. With this arrangement, it is possible to absorb vibrations of the pipe by elastic deformation of the pair of clamping members, and to effectively secure the vibration absorbing function by suppressing excessive pressing of the pair of clamping members by the spacer.

Specifically, the spacer may be a tubular member which passes through both of the pair of clamping members, and the pressing mechanism may include a fastening bolt which passes through the spacer and through the clamp presser, and a nut which is screwed into a lead end of the fastening bolt.

In the construction machine, preferably, the frame may have a placement surface on which the clamp body is placed, the attachment pin may project upwardly from the placement surface, the clamp body may be placed on the placement surface, with the clamp presser being directed upwardly, and the frame may be formed with a contact avoiding portion which avoids contact between the frame, and one of a head of the fastening bolt and the nut which is disposed below the frame.

In the above arrangement, the clamp body is placed on the placement surface, with the clamp presser being directed upwardly, and the contact avoiding portion avoids the contact between the frame, and one of the head of the fastening bolt and the nut which is disposed below the frame. With this arrangement, the contact between the members made of a metal (i.e. the frame, the clamp presser, the bolt, and the nut) is avoided to thereby effectively suppress transmission of vibrations via these metal members.

In the construction machine, preferably, the coupling mechanism may include a first washer which is disposed between the head of the fastening bolt and the pair of clamping members, and a second washer which is disposed between the nut and the pair of clamping members, and the contact avoiding portion may have such a size as to avoid the contact between the frame, and one of the first washer and the second washer which is disposed below the frame.

In the above arrangement, the first washer is disposed between the fastening bolt and the pair of clamping members, and the second washer is disposed between the nut and the pair of clamping members; and the contact avoiding portion has such a size as to avoid the contact between the frame and the first washer, and between the frame and the second washer. With this arrangement, the contact between the frame and the first washer, and between the frame and the second washer is avoided, while suppressing rotation of the pair of clamping members together with the fastening bolt and the nut, whereby transmission of vibrations from the pipe to the frame can be suppressed.

In the construction machine, preferably, the diameter of the clamping member pin hole may be set larger than the diameter of the attachment pin, and may be set smaller than the diameter of the clamp presser pin hole.

In the above arrangement, the diameter of the clamping member pin hole is set larger than the diameter of the attachment pin, and is set smaller than the diameter of the clamp presser pin hole. With this arrangement, since the attachment pin is contacted with the pair of clamping members before the attachment pin is contacted with the clamp presser when the clamp body is vibrated, it is possible to suppress contact between the attachment pin and the clamp presser, both of which are made of a metal. Thus, it is possible to more effectively suppress transmission of vibrations of the pipe to the frame.

Preferably, the construction machine may further include a lower propelling body, and the frame may be an upper frame which is loaded slewably onto the lower propelling body. The upper frame may include a partition plate which divides a space above the upper frame into a front section and a rear section, and a clamp receiver which bulges from the partition plate, with the attachment pin projecting upwardly, and the clamp body may be supported on the clamp receiver in a state that the attachment pin is received through the clamp body.

In the above arrangement, the attachment pin projects upwardly on the clamp receiver of the upper frame. With this arrangement, the clamp body is placed on the clamp receiver, with the attachment pin passing through the clamp body. This enables to attach the clamp body onto the frame, while suppressing transmission of vibrations to the upper frame via the partition plate.

Preferably, the construction machine may further include a stopper member which prevents disengagement of the clamp body from the attachment pin.

In the above arrangement, the construction machine is provided with the stopper member which prevents disengagement of the clamp body from the attachment pin. This enables to securely attach the clamp body onto the frame, while suppressing transmission of vibrations from the pipe to the frame as described above.

This application is based on Japanese Patent Application No. 2010-235770 filed on Oct. 20, 2010, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A construction machine, comprising:
a frame, with an attachment pin projecting therefrom; and
a clamp body attached to the frame,
the clamp body including
a pair of clamping members which sandwich a pipe from both sides of the pipe in a diameter direction thereof; and
a coupling mechanism which is operable to couple the pair of clamping members to each other in a state that the pipe is sandwiched between the pair of clamping members, wherein
each of the pair of clamping members is formed with a clamping member pin hole for passing the attachment pin therethrough, and
the attachment pin passes through both of the pair of clamping members via the clamping member pin holes, whereby the clamp body is attached onto the frame in a state that the clamp body is movable in a length direction of the attachment pin.

2. The construction machine according to claim 1, wherein
the pair of clamping members are made of an elastic material,
the coupling mechanism includes a metal clamp presser which is placed on one of the pair of clamping members, with the one of the pair of clamping members being interposed between the clamp presser and the other of the pair of clamping members, a pressing mechanism which presses the other of the pair of clamping members toward the clamp presser, and a spacer which keeps a thickness of the pair of clamping members to a predetermined size or more against a pressing force by the pressing mechanism, and
the clamp presser is formed with a clamp presser pin hole for passing the attachment pin therethrough, at a position corresponding to the clamping member pin hole.

3. The construction machine according to claim 2, wherein
the spacer is a tubular member which passes through both of the pair of clamping members, and
the pressing mechanism includes a fastening bolt which passes through the spacer and through the clamp presser, and a nut which is screwed into a lead end of the fastening bolt.

4. The construction machine according to claim 3, wherein
the frame has a placement surface on which the clamp body is placed,
the attachment pin projects upwardly from the placement surface,
the clamp body is placed on the placement surface, with the clamp presser being directed upwardly, and
the frame is formed with a contact avoiding portion which avoids contact between the frame, and one of a head of the fastening bolt and the nut which is disposed below the frame.

5. The construction machine according to claim 4, wherein
the coupling mechanism includes a first washer which is disposed between the head of the fastening bolt and the pair of clamping members, and a second washer which is disposed between the nut and the pair of clamping members, and
the contact avoiding portion has such a size as to avoid the contact between the frame, and one of the first washer and the second washer which is disposed below the frame.

6. The construction machine according to claim 2, wherein
the diameter of the clamping member pin hole is set larger than the diameter of the attachment pin, and is set smaller than the diameter of the clamp presser pin hole.

7. The construction machine according to claim 1, further comprising
a lower propelling body,
the frame being an upper frame which is loaded slewably onto the lower propelling body, wherein
the upper frame includes a partition plate which divides a space above the upper frame into a front section and a rear section, and a clamp receiver which bulges from the partition plate, with the attachment pin projecting upwardly, and
the clamp body is supported on the clamp receiver in a state that the attachment pin is received through the clamp body.

8. The construction machine according to claim 1, further comprising
a stopper member which prevents disengagement of the clamp body from the attachment pin.
